(19) United States
(12) Patent Application Publication
(10) Pub. No.: US 2021/0354992 A1
(43) Pub. Date: Nov. 18, 2021

(54) PRODUCTION OF FINE GRAIN MAGNESIUM OXIDE AND FIBROUS AMORPHOUS SILICA FROM SERPENTINITE MINE TAILINGS

(71) Applicant: MAG ONE OPERATIONS INC., Montréal (CA)

(72) Inventors: Gillian HOLCROFT, Montréal (CA); Gervais SOUCY, Sherbrooke (CA); YuMei HAN, Sherbrooke (CA); Denys PINARD, Asbestos (CA); Jean-Marc LALANCETTE, Sherbrooke (CA)

(21) Appl. No.: 17/250,585

(22) PCT Filed: Aug. 6, 2019
(86) PCT No.: PCT/CA2019/051076

§ 371 Date: Feb. 5, 2021

Related U.S. Application Data
(60) Provisional application No. 62/715,001, filed on Aug. 6, 2018.

(51) Int. Cl. C01F 5/06; C01B 33/12; C01G 49/02; C01G 53/04; C22B 3/06; C22B 7/00; C22B 26/22; C22B 1/00

(52) U.S. Cl. CPC C01F 5/06; C01B 33/12; C01G 49/02; C01G 53/04; C01P 2002/02; C22B 7/007; C22B 26/22; C22B 1/005; C22B 3/065

(57) ABSTRACT

The present disclosure broadly relates to a process for recovering magnesium as magnesium oxide and fibrous amorphous silica from serpentinite feedstocks. More specifically, but not exclusively, the present disclosure relates to metallurgical and chemical processes for recovering magnesium oxide and fibrous amorphous silica from serpentinite feedstocks. The process broadly comprises applying a sufficient amount of shear deformation force to the serpentine feedstocks to produce a particulate material of reduced size; subjecting the particulate material to magnetic separation to produce a primary magnetic separation product and iron-reduced tailings; and digesting the iron-reduced tailings into nitric acid, producing a magnesium-rich pregnant solution and insoluble solids. The process further comprises adjusting the pH of the pregnant solution to values ranging from about 5.0 to about 7.0.

### CROSS-REFERENCE TO RELATED APPLICATIONS

The present application claims the benefit of priority from U.S. provisional application No. 62/715,001 filed on Aug. 6, 2018, the contents of which are incorporated herein by reference in their entirety.

### FIELD

The present disclosure broadly relates to a process for recovering magnesium as magnesium oxide and fibrous amorphous silica from serpentinite feedstocks. More specifically, but not exclusively, the present disclosure relates to metallurgical and chemical processes for recovering magnesium oxide and fibrous amorphous silica from serpentinite feedstocks. In an aspect, the present disclosure relates to metallurgical and chemical processes for recovering magnesium oxide and fibrous amorphous silica from serpentinite mine tailings.

### BACKGROUND

The vast majority of magnesium oxide produced in the world comes from the mining and processing of dolomite (primarily magnesium carbonate and calcium carbonate) and magnesite (magnesium carbonate). However, substantial quantities of magnesium are also present in serpentinite, the rock formation used as the feed mineral to produce asbestos and asbestos-based products.

Asbestos mining has been halted for the most part worldwide due to health hazards associated with inhaling and in some cases ingesting of serpentine fibers. The exploitation of serpentinite (primarily chrysotile) deposits has left behind billions of tons of serpentinite tailings in the provinces of Quebec, Newfoundland and British Columbia (Canada), and Vermont (United States). The tailings from asbestos mining operations, which are for the most part undersized, commercially-unviable serpentine fibres, have the same chemical composition as the original mined mineral, including its content of magnesium oxide and silica (Table 1).

TABLE 1
Composition of Serpentinite Tailings

| | Compositions (%) | | | | | | | |
|---|---|---|---|---|---|---|---|---|
| Mines | MgO | SiO₂ | H₂O | Al₂O₃ | CaO | Ni | Cr | Fe |
| Jeffrey | 38.1 | 39.2 | 12.0 | 0.81 | 0.35 | 0.23 | 0.31 | 6.1 |
| Bell | 38.25 | 38.6 | 12.5 | 1.28 | 0.43 | 0.23 | 0.09 | 5.2 |
| Lac | 39.8 | 37.1 | 11.9 | 0.64 | 0.38 | 0.24 | 0.10 | 6.0 |
| Carey | 41.0 | 36.5 | 13.7 | 0.40 | 0.15 | 0.29 | 0.15 | 5.5 |

Chrysotile, one of the main forms of serpentine, stoichiometrically contains more magnesium than dolomite and magnesite. With energy and manpower having already been expended to mine and size-reduce these magnesium-rich serpentinite tailings, it would stand to reason that an important cost barrier to exploiting the magnesium has been avoided from the prior processing of these tailings. Moreover, dolomite and magnesite are carbonates. In calcining these ores to transform them to the oxide form, carbon dioxide is released to the atmosphere. Indeed, for each tonne of magnesium oxide ultimately produced from magnesite, 1.1 tonnes of carbon dioxide are released to the atmosphere directly from the mineral, not including emissions from the process. For dolomite, 2.2 tonnes of carbon dioxide are released to the atmosphere from the calcining of the mineral for each tonne of magnesium oxide produced.

Serpentine is a magnesium silicate that is characterized by the absence of carbon in the mineral. As such, a magnesium extraction process from serpentinite tailings will not emit any carbon dioxide from the mineral itself to the atmosphere, representing a significant advantage to the use of these tailings as a source of magnesium.

Several processes have been developed for the recovery of values from serpentinite tailings using a variety of reagents such as carbon dioxide (Can. Patent No. 2,248,474), sodium hydroxide (U.S. Pat. No. 4,478,796), hydrochloric acid (U.S. Pat. No. 7,780,941 B1), sulfur dioxide (U.S. Pat. No. 1,865,224), ammonium sulfate (U.S. Pat. No. 4,277,449), sulfuric acid (U.S. Pat. No. 2,402,370) and nitric acid (U.S. Pat. No. 1,454,583). Besides commercial considerations, the complexity of the species present in these tailings adversely impacts the recovery of purified products. To that effect, either acidic or alkaline treatment of the tailings leads to complex reaction mixtures along with high reagent consumption rates. Moreover, the recovery of the values of interest in high purity from these complex reaction mixtures poses a significant challenge.

The present disclosure refers to a number of documents, the contents of which are specifically incorporated herein by reference in their entirety.

### SUMMARY

A solution to the aforementioned problems, particularly problems associated with the recovery of magnesium from chrysotile, and more particularly problems associated with the recovery a magnesium from carcinogenic asbestos tailings materials has been fortuitously discovered. Broadly, the solution resides in the discovery that the use of nitric acid allows for rapid and substantially complete extraction of magnesium from the tailings materials leaving an amorphous silica rich residue that has a high degree of purity (in excess of 80%). Notably, a high purity magnesium oxide, a high purity amorphous silica rich residue and a nickel and cobalt rich residue are surprisingly obtained. In an aspect, the amorphous silica rich residue can be advantageously used as an additive to high performance concrete manufacturing. In an aspect, the magnesium nitrate solution, from the nitric acid digestion step, can be advantageously neutralized with recycled magnesium oxide to precipitate key impurities such as nickel, cobalt and iron to produce a nickel-rich residue. In an aspect, the magnesium values can be advantageously recovered from the substantially nickel-free magnesium nitrate solution by evaporation and thermal decomposition to produce a high purity magnesium oxide and a gas stream comprising HNO₃(g), NOₓ (g) and H₂O that can be used for nitric acid regeneration.

In an aspect, the present disclosure broadly relates to a process for recovering magnesium and fibrous amorphous silica from serpentinite feedstocks. More specifically, but not exclusively, the present disclosure relates to metallurgical and chemical processes for recovering magnesium oxide and fibrous amorphous silica from serpentinite feedstocks. In an aspect, the present disclosure relates to metallurgical and chemical processes for recovering magnesium oxide and fibrous amorphous silica from serpentinite mine tailings.

In an aspect, the present disclosure relates to a process for recovering magnesium oxide and/or fibrous amorphous silica from serpentinite feedstocks, the process comprising: applying a sufficient amount of shear deformation force to the serpentine feedstocks to produce a particulate material of reduced size; subjecting the particulate material to magnetic separation to produce a primary magnetic separation product and iron-reduced tailings; and digesting the iron-reduced tailings into nitric acid, producing a magnesium-rich pregnant solution and insoluble solids.

In an aspect, the present disclosure relates to a process for recovering magnesium oxide and/or fibrous amorphous silica from serpentinite feedstocks, the process comprising: applying a sufficient amount of shear deformation force to the serpentine feedstocks to produce a particulate material of reduced size; subjecting the particulate material to magnetic separation to produce a primary magnetic separation product and iron-reduced tailings; digesting the iron-reduced tailings into nitric acid, producing a magnesium-rich pregnant solution and insoluble solids; and adjusting the pH of the pregnant solution to values ranging from about 5.0 to about 7.0.

In an aspect, the present disclosure relates to a process for recovering magnesium oxide and/or fibrous amorphous silica from serpentinite feedstocks, the process comprising: applying a sufficient amount of shear deformation force to the serpentine feedstocks to produce a particulate material of reduced size; subjecting the particulate material to magnetic separation to produce a primary magnetic separation product and iron-reduced tailings; digesting the iron-reduced tailings into nitric acid, producing a magnesium-rich pregnant solution and insoluble solids; adjusting the pH of the pregnant solution to values ranging from about 5.0 to about 7.0; and thermally decomposing Mg(NO₃)₂(H₂O)ₓ to MgO, wherein x is a value ranging from 0 to 6.

In an embodiment of the present disclosure, the serpentinite feedstock comprises serpentinite tailings. In an embodiment of the present disclosure, the primary magnetic separation product comprises an iron-rich material. In an embodiment of the present disclosure, the iron-reduced tailings comprise a microfibrous material. In an embodiment of the present disclosure, the pregnant solution comprises magnesium nitrate and to a lesser extends the nitrates of at least one of iron, nickel and chromium.

In an embodiment of the present disclosure, the nitric acid digestion comprises using an aqueous solution of nitric acid having a mass percentage from about 5 wt. % HNO₃ to about 100 wt. % HNO₃. In a further embodiment of the present disclosure, the aqueous solution of nitric acid has a mass percentage from about 15 wt. % HNO₃ to about 99 wt. % HNO₃. In yet a further embodiment of the present disclosure, the aqueous solution of sulfuric acid has a mass percentage from about 30 wt. % HNO₃ to about 98 wt .% HNO₃.

In an embodiment of the present disclosure, the serpentinite feedstock is ground to a particle size of less than about 1.000 millimeter. In a further embodiment of the present disclosure, the serpentinite feedstock is ground to a particle size of less than about 0.750 millimeter.

In an embodiment of the present disclosure, the serpentinite feedstock is digested into nitric acid at a temperature ranging from about 80° C. to about 118° C. and stirred. In a further embodiment of the present disclosure, the serpentinite feedstock is digested into nitric acid at a temperature ranging from about 95° C. to about 110° C. and stirred. In a further embodiment of the present disclosure, the serpentinite feedstock is digested into nitric acid at a temperature ranging from about 100° C. to about 108° C. and stirred.

In an embodiment of the present disclosure, the nitric acid digestion is performed with a solution of nitric acid (L) and a mass of serpentinite feedstock (S) having a mass ratio (L-to-S) not exceeding twenty to one (20:1 or 20 kg/kg). In a further embodiment of the present disclosure, the mass ratio (L-to-S) is not exceeding ten to one (10:1 or 10 kg/kg). In a further embodiment of the present disclosure, the mass ratio (L-to-S) is not exceeding five to one (5:1 or 5 kg/kg).

In an embodiment of the present disclosure, the nitric acid digestion is performed over a period of at least one (1) hour. In a further embodiment of the present disclosure, the nitric acid digestion is performed over a period ranging from about one and a half (1.5) hours up to about ten (10) hours. In a further embodiment of the present disclosure, the nitric acid digestion is performed over a period ranging from about two (2) hours up to about eight (8) hours. In yet a further embodiment of the present disclosure, the nitric acid digestion is performed over a period ranging from about two and a half (2.5) hours up to about six (6) hours.

In an embodiment of the present disclosure, the filter cake obtained following nitric acid digestion is washed with water. In an embodiment of the present disclosure, the washing removes any residual nitric acid from the filter cake. In a further embodiment of the present disclosure, the filter cake comprises amorphous silica.

In an embodiment of the present disclosure, the shear deformation forces are generated by mechanical attrition. In an embodiment of the present disclosure, the mechanical attrition comprises the use of at least one of a ball or hammer mill.

In an embodiment of the present disclosure, the pH of the pregnant solution is adjusted to values ranging from about 5.0 to about 7.0. In a further embodiment of the present disclosure, the pH of the pregnant solution is adjusted to values ranging from about 5.5 to about 6.5. In a further embodiment of the present disclosure, the pH of the pregnant solution is adjusted by adding at least one of MgO or Mg(OH)₂. In a further embodiment of the present disclosure, adjusting the pH of the pregnant solution is accompanied by the addition of an oxidant. In yet a further embodiment of the present disclosure, the oxidant is at least one of ozone, hydrogen peroxide, sodium hypochlorite or magnesium hypochlorite. In an aspect of the present disclosure, the oxidant controls the Oxidation-Reduction Potential (ORP) of the pregnant solution. In an embodiment of the present disclosure, the ORP of the pregnant solution is maintained at values ranging from 300 mV to 1000 mV. In a further embodiment of the present disclosure, the ORP of the pregnant solution is maintained at values ranging from 450 mV to 700 mV. In yet a further embodiment of the present disclosure, the addition of the oxidant provides for the precipitation of metal impurities.

In an embodiment of the present disclosure, the thermal decomposition of the Mg(NO₃)₂(H₂O)ₓ to MgO, wherein x is a value ranging from 0 to 6, comprises heating the Mg(NO₃)₂(H₂O)ₓ to MgO, wherein x is a value ranging from 0 to 6, at temperatures ranging from about 400° C. to about 650° C. In a further embodiment of the present disclosure, the thermal decomposition is performed at temperatures ranging from about 450° C. to about 650° C. In a further embodiment of the present disclosure, the thermal decomposition is performed at temperatures ranging from about 475° C. to about 650° C.

In an aspect, the present disclosure relates to a process for recovering magnesium and fibrous amorphous silica from a carcinogenic waste material (asbestos tailings) with substantial recycling and reuse of the nitric acid. In an embodiment, the process comprises applying a sufficient amount of shear deformation force to the serpentine feedstocks to produce a particulate material of reduced size; subjecting the particulate material to magnetic separation to produce a primary magnetic separation product and iron-reduced tailings; and digesting the iron-reduced tailings into nitric acid, producing a magnesium-rich pregnant solution and insoluble solids.

Also disclosed in the context of the present disclosure are embodiments 1 to 57. Embodiment 1 is a process for recovering magnesium as magnesium oxide and fibrous amorphous silica from serpentinite feedstocks, the process comprising: applying a sufficient amount of shear deformation force to the serpentine feedstocks to produce a particulate material of reduced size; subjecting the particulate material to magnetic separation to produce a primary magnetic separation product and iron-reduced tailings; and digesting the iron-reduced tailings into nitric acid, producing a magnesium-rich pregnant solution and insoluble solids. Embodiment 2 is the process of embodiment 1, wherein the insoluble solids are separated from the pregnant solution by solid-liquid separation techniques producing a filter cake. Embodiment 3 is the process of embodiment 2, further comprising washing and/or drying the filter cake. Embodiment 4 is the process of any one of embodiments 1 to 3, wherein the insoluble solids comprise amorphous silica. Embodiment 5 is the process of any one of embodiments 1 to 4, wherein the shear deformation forces are generated by mechanical attrition. Embodiment 6 is the process of embodiment 5, wherein the mechanical attrition is at least one of a ball or hammer mill. Embodiment 7 is the process of any one of embodiments 1 to 6, wherein the primary magnetic separation product comprises an iron-rich material. Embodiment 8 is the process of any one of embodiments 1 to 7, wherein the iron-reduced tailings comprise a microfibrous material. Embodiment 9 is the process of any one of embodiments 1 to 8, wherein the pregnant solution comprises magnesium nitrate. Embodiment 10 is the process of any one of embodiments 1 to 9, wherein the nitric acid digestion is performed at temperatures ranging from about 80° C. to about 118° C. Embodiment 11 is the process of embodiment 10, wherein the nitric acid digestion is performed at temperatures ranging from about 95° C. to about 110° C. Embodiment 12 is the process of embodiment 10 or 11, wherein the nitric acid digestion is performed at temperatures from about 100° C. to about 108° C. Embodiment 13 is the process of embodiment 2, further comprising adjusting the pH of the pregnant solution to values ranging from about 5.0 to about 7.0. Embodiment 14 is the process of embodiment 13, wherein the pH of the pregnant solution is adjusted to values ranging from about 5.5 to about 6.5. Embodiment 15 is the process of embodiment 13 or 14, wherein adjusting the pH of the pregnant solution comprises adding at least one of MgO or Mg(OH)2. Embodiment 16 is the process of embodiment 2, further comprising adjusting the oxidation-reduction potential (ORP) of the pregnant solution to values ranging from 300 mV to 1000 mV. Embodiment 17 is the process of embodiment 16, wherein the oxidation-reduction potential (ORP) of the pregnant solution is adjusted to values ranging from 450 mV to 750 mV. Embodiment 18 is the process of any one of embodiment 13 to 15, further comprising adjusting the ORP of the pregnant solution to values ranging from 300 mV to 1000 mV. Embodiment 19 is the process of embodiment 18, wherein the ORP of the pregnant solution is adjusted to values ranging from 450 mV to 750 mV. Embodiment 20 is the process of any one of embodiments 16 to 19, wherein the ORP of the pregnant solution is adjusted by adding an oxidant to the pregnant solution. Embodiment 21 is the process of embodiment 20, wherein the oxidant is at least one of ozone, hydrogen peroxide, sodium hypochlorite or magnesium hypochlorite. Embodiment 22 is the process of any one of embodiments 13 to 21, wherein adjusting the pH produces a second pregnant solution further enriched in magnesium and a metal oxide and metal hydroxide-containing precipitate. Embodiment 23 is the process of embodiment 22, wherein the metal oxide and metal hydroxide-containing precipitate is separated from the second pregnant solution by solid-liquid separation techniques producing a filter cake. Embodiment 24 is the process of embodiment 23, further comprising washing and/or drying the filter cake. Embodiment 25 is the process of any one of embodiments 22 to 24, wherein the metal hydroxide comprises hydroxides of iron and nickel. Embodiment 26 is the process of any one of embodiments 22 to 25, further comprising recovering magnesium values from the second pregnant solution further enriched in magnesium. Embodiment 27 is the process of embodiment 26, wherein the magnesium values are recovered by evaporation of Mg(NO₃)₂(H₂O)ₓ, wherein x is a value ranging from 0 to 6, followed by thermal decomposition. Embodiment 28 is the process of embodiment 26, wherein the magnesium values are recovered by thermal decomposition of Mg(NO₃)₂(H₂O)ₓ to MgO, wherein x is a value ranging from 0 to 6. Embodiment 29 is the process of embodiment 27 or 28, wherein the thermal decomposition is performed at temperatures ranging from about 400° C. to about 650° C. Embodiment 30 is the process of embodiment 29, wherein the thermal decomposition is performed at temperatures ranging from about 450° C. to about 650° C. Embodiment 31 is the process of embodiment 29 or 30, wherein the thermal decomposition is performed at temperatures ranging from about 475° C. to about 650° C. Embodiment 32 is the process of any one of embodiments 27 to 31, wherein the thermal decomposition is performed at atmospheric pressure. Embodiment 33 is the process of any one of embodiments 27 to 32, wherein the thermal decomposition is performed under reduced pressure. Embodiment 34 is the process of any one of embodiments 27 to 33, wherein the thermal decomposition is performed by spray roasting. Embodiment 35 is the process of any one of embodiments 27 to 33, wherein the thermal decomposition is performed by fluidized bed. Embodiment 36 is the process of any one of embodiments 27 to 33, wherein the thermal decomposition is performed using a rotary kiln or a hearth furnace. Embodiment 37 is the process of embodiment 26, further comprising concentrating the second pregnant solution further enriched in magnesium. Embodiment 38 is the process of any one of embodiments 1 to 12, wherein the nitric acid digestion comprises using an aqueous solution of nitric acid having a mass percentage from about 5 wt. % HNO₃ to about 100 wt. % HNO₃. Embodiment 39 is the process of embodiment 38, wherein the aqueous solution of nitric acid has a mass percentage from about 15 wt. % HNO₃ to about 99 wt. % HNO₃. Embodiment 40 is the process of embodiment 38 or 39, wherein the aqueous solution of nitric acid has a mass percentage from about 25 wt. % HNO₃ to about 98 wt. % HNO₃. Embodiment 41 is the process of any one of embodiments 1 to 6, wherein the particulate material comprises a particle size of less than about 1.000 millimeter. Embodiment 42 is the process of embodiment 41, wherein the particulate material comprises a particle size of less than about 0.750 millimeter. Embodiment 43 is the process of embodiment 1, wherein the nitic acid digestion is performed with a solution of nitric acid (L) and a mass of iron-reduced tailings (S) having a mass ratio (L-to-S) not exceeding twenty to one (20:1 or 20 kg/kg). Embodiment 44 is the process of embodiment 43, wherein the mass ratio (L-to-S) is not exceeding ten to one (10:1 or 10 kg/kg). Embodiment 45 is the process of embodiment 43 or 44, wherein the mass ratio (L-to-S) is not exceeding five to one (5:1 or 5 kg/kg). Embodiment 45 is the process of embodiment 1, wherein the nitric acid digestion is performed over a period of at least one hour. Embodiment 47 is the process of embodiment 46, wherein the nitric acid digestion is performed over a period ranging from about one and a half (1.5) hours up to about ten (10) hours. Embodiment 48 is the process of embodiment 46 or 47, wherein the nitric acid digestion is performed over a period ranging from about two (2) hours up to about eight (8) hours. Embodiment 49 is the process of any one of embodiments 46 to 48, wherein the nitric acid digestion is performed over a period ranging from about two and a half (2.5) hours up to about six (6) hours. Embodiment 50 is the process of embodiment 1, wherein the nitric acid digestion is performed at atmospheric pressure. Embodiment 51 is the process of embodiment 1, wherein the nitric acid digestion is performed under reduced pressure. Embodiment 52 is the process of embodiment 1, wherein the nitric acid digestion is performed batch wise. Embodiment 53 is the process of embodiment 49, wherein the nitric acid digestion is performed using a corrosion resistant vessel. Embodiment 54 is the process of embodiment 1, wherein the nitric acid digestion is performed semi-continuously or continuously. Embodiment 55 is the process of embodiment 1, wherein the nitric acid digestion is performed using a corrosion resistant vessel. Embodiment 56 is the process of embodiment 1, wherein the pregnant solution is at a pH below 3.0. Embodiment 57 is the process of any one of embodiment 1 to 56, further comprising a nitric acid recycling step. Embodiment 58 is the process of embodiment 57, wherein the recycled nitric acid is brought back to produce a leaching solution for digesting the iron-reduced tailings.

The foregoing and other objects, advantages and features of the present disclosure will become more apparent upon reading of the following non-restrictive description of illustrative embodiments thereof, given by way of example only with reference to the accompanying drawings/figures.

### BRIEF DESCRIPTION OF THE DRAWINGS/FIGURES

In the appended drawings/figures:

FIG. 1 is an illustration of a flowchart illustrating an aspect of the process for preparing microfiber-rich, iron-reduced tailings from serpentinite feedstocks, in accordance with an embodiment of the present disclosure.

FIG. 2 is an illustration of a flowchart illustrating an aspect of the process for preparing microfiber-rich, iron-reduced tailings from serpentinite feedstocks, in accordance with a further embodiment of the present disclosure.

FIG. 3 is an illustration of a flowchart illustrating an aspect of the process for recovering magnesium oxide and fibrous amorphous silica from serpentinite feedstocks, in accordance with an embodiment of the present disclosure.

FIG. 4 is an illustration of a flowchart illustrating an aspect of the process for recovering magnesium oxide and fibrous amorphous silica from serpentinite feedstocks, in accordance with a further embodiment of the present disclosure.

FIG. 5 is an illustration of a flowchart illustrating an aspect of the process for preparing microfiber-rich, iron-reduced tailings from serpentinite feedstocks, in accordance with a further embodiment of the present disclosure.

### DETAILED DESCRIPTION

Glossary

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Unless otherwise indicated, the definitions and embodiments described in this and other sections are intended to be applicable to all embodiments and aspects of the application herein described for which they are suitable as would be understood by a person skilled in the art.

The word “a” or “an” when used in conjunction with the term “comprising” in the claims and/or the disclosure may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this disclosure and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±1% of the modified term if this deviation would not negate the meaning of the word it modifies.

As used herein, the term “serpentinite feedstocks” refers to a range of materials containing magnesium in various oxidation states (Mg(II) and magnesium metal) such as but not restricted to serpentinite mine tailings.

As used herein, the term “nitric acid digestion” broadly refers to the digestion of a solid with nitric acid having a concentration ranging from 5 wt. % to 100 wt. %.

The term “substantially” as used herein with reference to the process steps disclosed herein means that the process steps proceed to an extent that conversion or recovery of the material is maximized. For example, with reference to recovery of a given metallic value, recovery means that at least 90% of the value is recovered.

The present disclosure broadly relates to the combination of metallurgical and chemical processes for recovering magnesium and silica values from serpentinite feedstocks such as serpentinite mine tailings with the concurrent separation of iron, nickel and chromium values as insoluble solid residues.

In an embodiment of the present disclosure, the serpentinite mine tailings have been generated during asbestos production activities as a result of the extraction of the commercially viable long asbestos fibres (down to 1 mm) from the mineral. These fibres represent about 3-5% of the mined ore, the remaining material being discarded as tailings. A second crop of fibres can be obtained by the application of shear deformation forces. This second crop of fibres comprises much shorter fibres as well as microfibers. In an embodiment of the present disclosure, the shear deformation forces are generated by mechanical attrition. In a further embodiment of the present disclosure, the mechanical attrition comprises the use of at least one of a ball or hammer mill.

Chrysotile fibres, even though derived from rather complex materials (Table 1), comprise a rather pure form of magnesium silicate (3MgO.2SiO₂.2H₂O), with a level of impurities on the order of about 10%, the main impurity being iron. In fact, the quality of the chrysotile fibre is very much linked to the purity of the fibre itself, meaning the removal of non-fibrous species (the “grit”) mixed with the fibres. This was accomplished during asbestos production by successive air suspension and screening processes.

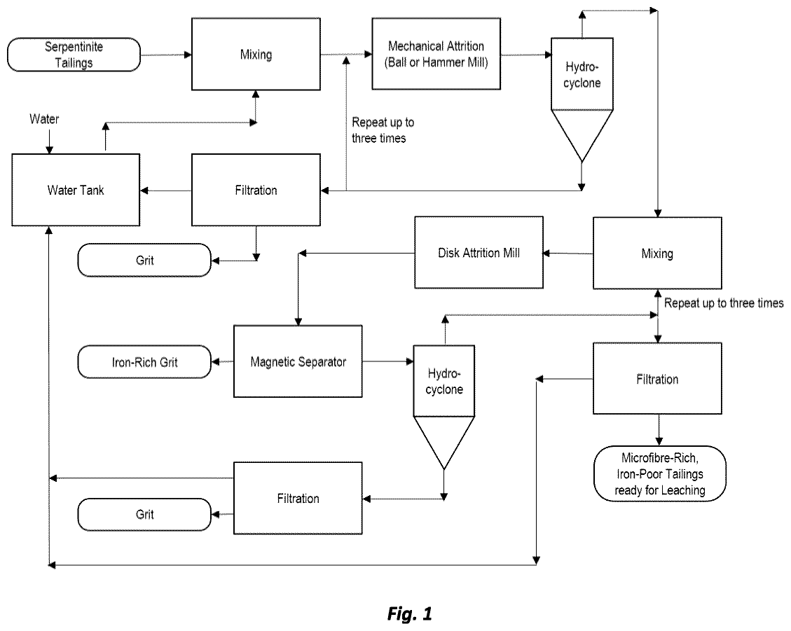

In an embodiment of the present disclosure, the serpentinite mine tailings are processed by the application of shear deformation forces (i.e. mechanical attrition) in order to remove the grit from the tailings, resulting in magnesium silicate of enhanced purity. However, grit removal becomes increasingly difficult with shorter fibre size. Subjecting the material to hydrocycloning, and repeating the attrition/hydrocycloning steps up to six times results in microfibers having impurity levels not exceeding 1%. In an embodiment of the present disclosure, a slurry of the crude serpentinite mine tailings, having a solids content of about 5% to about 15%, is subjected to shear deformation forces (i.e. mechanical attrition) and then fed into a hydrocyclone in order to separate the remaining grit from the microfibres. In a further embodiment of the present disclosure, the shear deformation forces are applied by feeding the slurry between a pair of rotating disks (i.e. a disk attrition mill). In a further embodiment of the present disclosure, the serpentinite mine tailings are subjected to a magnetic separation step in order to remove the magnetic fraction therefrom. In a further embodiment, the magnetic fraction substantially comprises the iron values of the tailings. The magnetic separation step can be performed prior to the application of the shear deformation forces, after the application of the shear deformation forces or, prior and after the application of the shear deformation forces (FIG. 1).

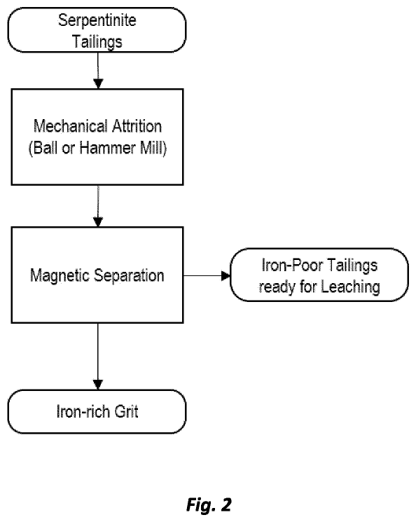

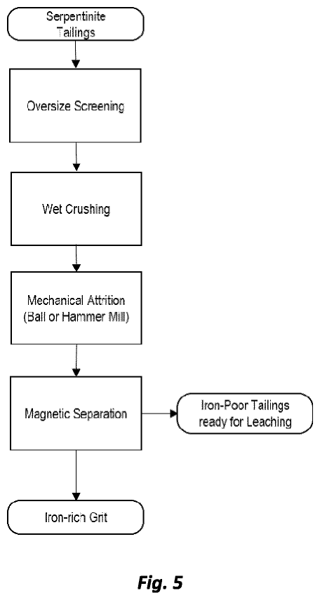

In a further embodiment of the present disclosure, the serpentinite mine tailings are processed by the application of shear deformation forces (i.e. mechanical attrition) in order to remove the grit from the tailings and to produce a particulate material of reduced size. In an embodiment of the present disclosure, the serpentinite feedstock is ground to a particle size of less than about 1.000 millimeter and in a further embodiment to a particle size of less than about 0.750 millimeter. However, extremely fine grinding (e.g. to a size below 0.250 millimeter) is not necessary in order to prevent excessive dusting during further processing. The particulate material is then subjected to magnetic separation to produce a tailings product from which a substantial portion of the iron-based grit has been removed (FIGS. 2 and 5).

In an embodiment, the present disclosure relates to a process comprising nitric acid digestion of microfiber-rich, iron-reduced tailings from serpentinite feedstocks. In an embodiment, the mass percentage of nitric acid used during this step ranges from 5 wt. % HNO₃ to 100 wt. % HNO₃. In a further embodiment, the mass percentage of nitric acid ranges from 15 wt. % HNO₃ to 99 wt. % HNO₃. In yet a further embodiment, the mass percentage of nitric acid ranges from 30 wt. % HNO₃ to 98 wt. % HNO₃. In yet a further embodiment of the present disclosure, the nitric acid digestion provides for a pregnant solution comprising the nitrates of magnesium and at least one of iron, nickel and chrome while also producing an insoluble residue composed substantially of high grade amorphous silica. In an embodiment, the nitric acid digestion of the microfiber-rich, iron-reduced tailings is in accordance with the following reactions:

3MgO.2SiO₂(s)+6 HNO₃(aq)=2 SiO₂(s)+3 H₂O (aq)+3 Mg(NO₃)₂ (aq)

Fe₂O₃(s)+6 HNO₃(aq)=2 Fe(NO₃)₃(aq)+3 H₂O(aq)

In an embodiment of the present disclosure, the microfiber-rich, iron-reduced tailings are mixed intimately with an amount of nitric acid sufficient to obtain a suspension, a slurry or a paste and the temperature is raised by heating the charge until the set temperature is reached.

In a further embodiment, the nitric acid digestion is performed with a mass ratio of the nitric acid solution (L) to the mass of iron-reduced tailings (S), denoted (L-to-S) not exceeding twenty to one (20:1 or 20 kg/kg). In a further embodiment the (L-to-S) mass ratio is not exceeding ten to one (10:1 or 10 kg/kg). In a further embodiment the (L-to-S) mass ratio is not exceeding five to one (5:1 or 5 kg/kg). In yet a further embodiment of the present disclosure, the nitric acid digestion is performed at temperatures ranging from about 80° C. to about 118° C., in a further embodiment from about 95° C. to 110° C. and in a further embodiment from about 100° C. to 108° C. In a further embodiment of the present disclosure, the nitric acid digestion is performed over a period of at least one hour. In a further embodiment, the nitric acid digestion is performed over a period ranging from about one and a half (1.5) hours up to about ten (10) hours; in a further embodiment over a period ranging from about two (2) hours up to about eight (8) hours; and in a further embodiment over a period ranging from about two and a half (2.5) hours up to about six (6) hours.

In an embodiment of the present disclosure, the nitric acid digestion is performed using an excess of nitric acid. In an embodiment of the present disclosure, the nitric acid digestion is performed using an excess of nitric acid to at least compensate for the loss of nitric acid by evaporation.

In an embodiment of the present disclosure, the nitric acid digestion is performed in air or under atmospheric pressure.

In an embodiment of the present disclosure, the nitric acid digestion is performed in air or under reduced pressure.

In an embodiment of the present disclosure, the nitric acid digestion is performed either batch wise using a brick-lined digester or another suitable corrosion resistant vessel or it is performed continuously. Other suitable apparatuses are known in the art, and are within the capacity of a skilled technician.

In yet a further embodiment of the present disclosure, the nitric acid digestion is performed inside a containment vessel or digester constructed of materials capable of withstanding both the temperatures and elevated corrosiveness of the nitric acid without contaminating the products by releasing deleterious metallic impurities. Non-limiting examples of corrosion resistant construction materials include high silicon cast iron with 14 wt. % Si (Duriron®), high nickel-alloys such as Hastelloy® B2, Hastelloy® C-276, carbon steels coated with a coating of enamel, or glass, or with an inert, protective and impervious polymer lining made of a highly corrosion resistant materials such as enamel, tantalum or glass, or polymers. Non-limiting protective lining materials include TFE, PVDF, PTFE, PFA or a combination thereof. Another solution extensively used industrially consists in the use of digesters made of a carbon steel shell lined internally with a first impervious layer made of plastics, elastomers or lead metal acting as a protective membrane and protected from the heat and abrasion of the nitration reaction with a second lining of refractory brick such as but not restricted to high silica bricks that are assembled with an acid resistant mortar made of silica and potassium silicate.

In a further embodiment of the present disclosure, once the nitric acid digestion is completed, that is, after a given reaction time has elapsed (ranging between one (1) hour to several hours depending on the acid number and the operating temperature) substantially all the magnesium values initially contained in the tailings have been entirely reacted, forming the related magnesium nitrate while the silica remain in the insoluble residue, the heating is stopped and the reaction mixture is allowed to cool down to room temperature.

In a further embodiment of the present disclosure, the pH of the acidic pregnant solution is at or below 3.0. In an embodiment of the present disclosure, the pH of the acidic pregnant solution is at or below 2.0. In an embodiment of the present disclosure, the pH of the acidic pregnant solution is at or below 1.5. In an embodiment of the present disclosure, the pH of the acidic pregnant solution is at or below 1.0.

In a further embodiment of the present disclosure, the acidic pregnant solution is subjected to a common clarification step using well known solid-liquid separation techniques, non-limiting examples of which include filtration, wet cycloning or centrifugation, in order to remove the insoluble solid residue composed substantially of high-grade amorphous silica. In yet a further embodiment of the present disclosure, the filter cake comprising the insoluble solid residue is subjected to further washings to remove any residual nitric acid therefrom. The high-grade amorphous silica typically comprises a silica content ranging from about 80% to about 95% (% SiO₂ on a dry basis) and having a surface area ranging from about 250 m²/g to about 400 m²/g.

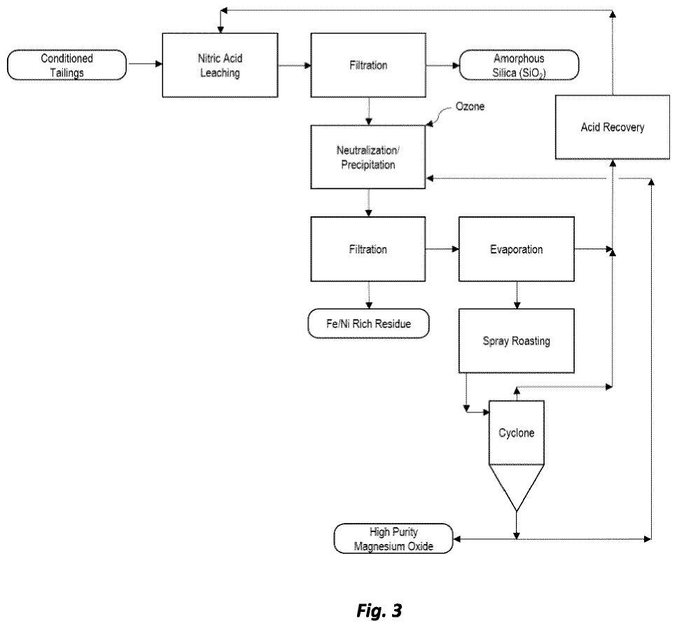

In a further embodiment of the present disclosure, the clear pregnant solution obtained after clarification contains substantially magnesium, and to a lesser extent some iron, nickel and chromium as metal nitrates. The removal of dissolved magnesium from the clear pregnant solution is initiated by the selective precipitation of the non-magnesium values as metal hydroxides. The non-magnesium values are precipitated by incrementally adjusting the pH of the clear pregnant solution to values ranging from about 5.0 to about 7.0 In an embodiment of the present disclosure, the pH of the clear pregnant solution is adjusted to values ranging from about 5.5 to 6.5. The pH of the clear pregnant solution is raised to values ranging from about 5.0 to about 7.0 by neutralization using at least one of MgO or Mg(OH)₂. In an embodiment of the present disclosure, the neutralization step further comprises injecting an oxidant into the clear pregnant solution to precipitate any traces of metal impurities that might be present. Non-limiting examples of suitable oxidants include ozone, hydrogen peroxide, sodium hypochlorite or magnesium hypochlorite. The amount of oxidant injected is typically controlled by an Oxidation-Reduction Potential (ORP) with a set point ranging between about 300 mV and about 1000 mV. In an embodiment of the present disclosure, the amount of oxidant injected controls the ORP with a set point ranging between about 450 mV and about 700 mV. The metal hydroxide containing precipitate is subsequently removed using well known solid-liquid separation techniques, non-limiting examples of which include filtration, wet cycloning or centrifugation. In an embodiment of the present disclosure, the precipitate comprises substantially iron and nickel hydroxides. In an embodiment of the present disclosure, the precipitate is sent to a nickel smelter for metal recovery. In a further embodiment of the present disclosure, the filtered pregnant solution comprises a concentration of magnesium nitrate ranging from about 2 wt % to about 25 wt % (FIG. 3).

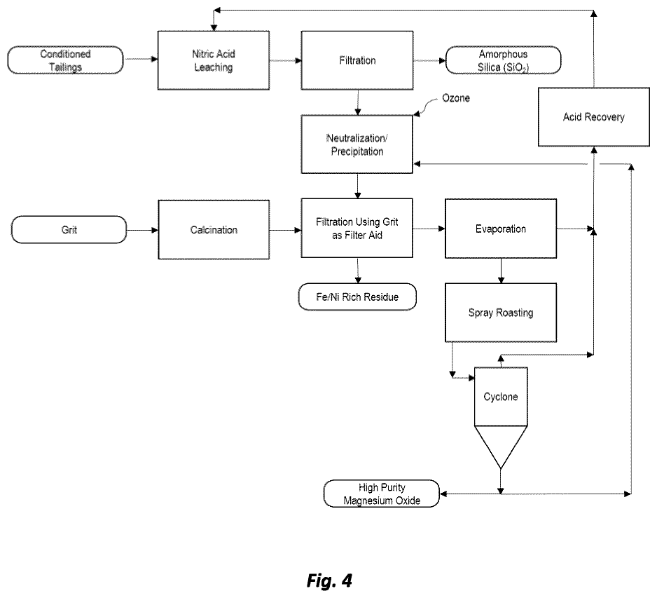

In an embodiment of the present disclosure, the previously obtained grit is used as a filter aid to help filter and recover the metal hydroxides from the pregnant solution. To that effect, the grit is calcined at temperatures ranging from about 600° C. to about 800° C. to reduce the surface area and to remove the asbestos hazards associated with this material. Following filtration, the combined metal hydroxides and filter aid is sent to a nickel smelter for metal recovery (FIG. 4).

In a further embodiment of the present disclosure, the magnesium nitrate is oxidized into magnesium oxide with the concomitant generation of nitric acid which is recirculated to regenerate the nitric acid to be used in the acid digestion step. The oxidation process is initiated by subjecting the magnesium nitrate containing solution to a concentration step wherein the solution is heated at temperatures ranging from about 30° C. to about 150° C. In an embodiment of the present disclosure, the concentration step is performed using a standard evaporator/dehydrator. In a further embodiment of the present disclosure, the evaporator/dehydrator is operated at pressures ranging from about 5 kPa to about 100 kPa. Following the concentration step, the aqueous Mg(NO₃)₂ comprises a bound water ratio ranging from about 0 to about 6 moles of water per mole of Mg(NO₃)₂. In a further embodiment of the present disclosure, the magnesium species subjected to thermal decomposition is represented by Mg(NO₃)₂(H₂O)ₓ, wherein x is a value ranging from 0 to 6.

The energy to decompose magnesium nitrate to MgO is lower than with other salts. For example; magnesium sulfate does not decompose until much higher temperatures. Magnesium chloride also decomposes at very high temperatures and makes a more refractory material (MgO) that does not behave as well in neutralization duty (purification). In a further embodiment of the present disclosure, the concentrated solution is subjected to evaporation/thermal decomposition to convert the magnesium nitrate species in to MgO. In an embodiment of the present disclosure, the thermal decomposition is performed by feeding the concentrated magnesium nitrate solution into a spray roaster. In a further embodiment of the present disclosure, the thermal decomposition is performed using a fluidized bed. In yet a further embodiment of the present disclosure, the thermal decomposition is performed using a rotary kiln or a hearth furnace. Other suitable apparatuses are known in the art, and are within the capacity of a skilled technician. In a further embodiment of the present disclosure, the spray roaster is operated at pressures ranging from about 25 kPa to about 100 kPa. In a further embodiment of the present disclosure, the thermal decomposition is performed at temperatures in excess of 150° C. under reduced pressure. In a further embodiment of the present disclosure, the thermal decomposition is performed at temperatures ranging from about 400° C. to about 650° C. at atmospheric pressure. In a further embodiment of the present disclosure, the thermal decomposition is performed at temperatures ranging from about 450° C. to about 650° C. at atmospheric pressure. In a further embodiment of the present disclosure, the thermal decomposition is performed at temperatures ranging from about 475° C. to about 650° C. at atmospheric pressure. In an embodiment, the thermal decomposition of magnesium nitrate into magnesium oxide is in accordance with the following reaction.

2 Mg(NO₃)₂(1, s)→2 MgO(s)+4 NO₂(g)+O₂(g)

In another embodiment of the present disclosure, the magnesium oxide is captured using a cyclone or other suitable apparatuses known in the art and within the capacity of a skilled technician. In yet another embodiment of the present disclosure, the magnesium oxide has a purity in excess of 98%.

The nitric acid and NOₓ gases generated during both the concentration and thermal decomposition steps are captured in an acid regeneration system to regenerate nitric acid for leaching. A series of scrubbers columns are used to capture the NOₓ and regenerate the nitric acid for the acid digestion of the serpentinite feedstocks.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

1. A process for recovering magnesium oxide and fibrous amorphous silica from serpentinite feedstocks, the process comprising:
applying a sufficient amount of shear deformation force to the serpentine feedstocks to produce a particulate material of reduced size;
subjecting the particulate material to magnetic separation to produce a primary magnetic separation product and iron-reduced tailings; and
digesting the iron-reduced tailings into nitric acid, producing a magnesium-rich pregnant solution and insoluble solids.

2. The process of claim 1, wherein the insoluble solids are separated from the pregnant solution by solid-liquid separation techniques producing a filter cake.

3. The process of claim 2, further comprising washing and/or drying the filter cake.

4. The process of any one of claims 1 to 3, wherein the insoluble solids comprise amorphous silica.

5. The process of any one of claims 1 to 4, wherein the shear deformation forces are generated by mechanical attrition.

6. The process of claim 5, wherein the mechanical attrition is at least one of a ball or hammer mill.

7. The process of any one of claims 1 to 6, wherein the primary magnetic separation product comprises an iron-rich material.

8. The process of any one of claims 1 to 7, wherein the iron-reduced tailings comprise a microfibrous material.

9. The process of any one of claims 1 to 8, wherein the pregnant solution comprises magnesium nitrate.

10. The process of any one of claims 1 to 9, wherein the nitric acid digestion is performed at temperatures ranging from about 80° C. to about 118° C.

11. The process of claim 10, wherein the nitric acid digestion is performed at temperatures ranging from about 95° C. to about 110° C.

12. The process of claim 10 or 11, wherein the nitric acid digestion is performed at temperatures from about 100° C. to about 108° C.

13. The process of claim 2, further comprising adjusting the pH of the pregnant solution to values ranging from about 5.0 to about 7.0.

14. The process of claim 13, wherein the pH of the pregnant solution is adjusted to values ranging from about 5.5 to about 6.5.

15. The process of claim 13 or 14, wherein adjusting the pH of the pregnant solution comprises adding at least one of MgO or Mg(OH)₂.

16. The process of claim 2, further comprising adjusting the oxidation-reduction potential (ORP) of the pregnant solution to values ranging from 300 mV to 1000 mV.

17. The process of claim 16, wherein the oxidation-reduction potential (ORP) of the pregnant solution is adjusted to values ranging from 450 mV to 750 mV.

18. The process of any one of claims 13 to 15, further comprising adjusting the ORP of the pregnant solution to values ranging from 300 mV to 1000 mV.

19. The process of claim 18, wherein the ORP of the pregnant solution is adjusted to values ranging from 450 mV to 750 mV.

20. The process of any one of claims 16 to 19, wherein the ORP of the pregnant solution is adjusted by adding an oxidant to the pregnant solution.

21. The process of claim 20, wherein the oxidant is at least one of ozone, hydrogen peroxide, sodium hypochlorite or magnesium hypochlorite.

22. The process of any one of claims 13 to 21, wherein adjusting the pH produces a second pregnant solution further enriched in magnesium and a metal oxide and metal hydroxide-containing precipitate.

23. The process of claim 22, wherein the metal oxide and metal hydroxide-containing precipitate is separated from the second pregnant solution by solid-liquid separation techniques producing a filter cake.

24. The process of claim 23, further comprising washing and/or drying the filter cake.

25. The process of any one of claims 22 to 24, wherein the metal hydroxide comprises hydroxides of iron and nickel.

26. The process of any one of claims 22 to 25, further comprising recovering magnesium values from the second pregnant solution further enriched in magnesium.

27. The process of claim 26, wherein the magnesium values are recovered by evaporation of Mg(NO₃)₂(H₂O)ₓ, wherein x is a value ranging from 0 to 6, followed by thermal decomposition.

28. The process of claim 26, wherein the magnesium values are recovered by thermal decomposition of Mg(NO₃)₂(H₂O)ₓ, to MgO, wherein x is a value ranging from 0 to 6.

29. The process of claim 27 or 28, wherein the thermal decomposition is performed at temperatures ranging from about 400° C. to about 650° C.

30. The process of claim 29, wherein the thermal decomposition is performed at temperatures ranging from about 450° C. to about 650° C.

31. The process of claim 29 or 30, wherein the thermal decomposition is performed at temperatures ranging from about 475° C. to about 650° C.

32. The process of any one of claims 27 to 31, wherein the thermal decomposition is performed at atmospheric pressure.

33. The process of any one of claims 27 to 32, wherein the thermal decomposition is performed under reduced pressure.

34. The process of any one of claims 27 to 33, wherein the thermal decomposition is performed by spray roasting.

35. The process of any one of claims 27 to 33, wherein the thermal decomposition is performed by fluidized bed.

36. The process of any one of claims 27 to 33, wherein the thermal decomposition is performed using a rotary kiln or a hearth furnace.

37. The process of claim 26, further comprising concentrating the second pregnant solution further enriched in magnesium.

38. The process of any one of claims 1 to 12, wherein the nitric acid digestion comprises using an aqueous solution of nitric acid having a mass percentage from about 5 wt. % HNO₃ to about 100 wt. % HNO₃.

39. The process of claim 38, wherein the aqueous solution of nitric acid has a mass percentage from about 15 wt. % HNO₃ to about 99 wt. % HNO₃.

40. The process of claim 38 or 39, wherein the aqueous solution of nitric acid has a mass percentage from about 25 wt. % HNO₃ to about 98 wt. % HNO₃.

41. The process of any one of claims 1 to 6, wherein the particulate material comprises a particle size of less than about 1.000 millimeter.

42. The process of claim 41, wherein the particulate material comprises a particle size of less than about 0.750 millimeter.

43. The process of claim 1, wherein the nitic acid digestion is performed with a solution of nitric acid (L) and a mass of iron-reduced tailings (S) having a mass ratio (L-to-S) not exceeding twenty to one (20:1 or 20 kg/kg).

44. The process of claim 43, wherein the mass ratio (L-to-S) is not exceeding ten to one (10:1 or 10 kg/kg). WO 2020/028980 PCT/CA2019/051076

45. The process of claim 43 or 44, wherein the mass ratio (L-to-S) is not exceeding five to one (5:1 or 5 kg/kg).

46. The process of claim 1, wherein the nitric acid digestion is performed over a period of at least one hour.

47. The process of claim 46, wherein the nitric acid digestion is performed over a period ranging from about one and a half (1.5) hours up to about ten (10) hours.

48. The process of claim 46 or 47, wherein the nitric acid digestion is performed over a period ranging from about two (2) hours up to about eight (8) hours.

49. The process of any one of claims 46 to 48, wherein the nitric acid digestion is performed over a period ranging from about two and a half (2.5) hours up to about six (6) hours.

50. The process of claim 1, wherein the nitric acid digestion is performed at atmospheric pressure.

51. The process of claim 1, wherein the nitric acid digestion is performed under reduced pressure.

52. The process of claim 1, wherein the nitric acid digestion is performed batch wise.

53. The process of claim 49, wherein the nitric acid digestion is performed using a corrosion resistant vessel.

54. The process of claim 1, wherein the nitric acid digestion is performed semi-continuously or continuously.

55. The process of claim 1, wherein the nitric acid digestion is performed using a corrosion resistant vessel.

56. The process of claim 1, wherein the pregnant solution is at a pH below 3.0.

57. The process of any one of claims 1 to 56, further comprising a nitric acid recycling step.

58. The process of claim 57, wherein the recycled nitric acid is brought back to produce a leaching solution for digesting the iron-reduced tailings.
